(19) United States
(12) Patent Application Publication
(10) Pub. No.: US 2016/0350735 A1
(43) Pub. Date: Dec. 1, 2016

(54) REMOTE VEHICLE FEATURE UNLOCK USING A SCANNABLE IDENTIFIER

(71) Applicant: AGCO Corporation, Hesston, KS (US)

(72) Inventors: Josh Wade Russell, Hesston, KS (US); Ben Rudolph Hecksher, Front Royal, VA (US)

(21) Appl. No.: 15/144,235

(22) Filed: May 2, 2016

Related U.S. Application Data
(60) Provisional application No. 62/166,830, filed on May 27, 2015.

(51) Int. Cl. G06Q 20/18; G06Q 20/32

(52) U.S. Cl. CPC G06Q 20/18; G06Q 20/3276; G06Q 2220/00

(57) ABSTRACT

In one embodiment, a method comprising presenting, on a display screen of a console of a vehicle, a bar code; receiving an encrypted activation code at the console, the encrypted activation code based on user selection of a purchasable feature corresponding to the bar code, the purchasable feature comprising a locked feature associated with the vehicle; decrypting the encrypted activation code, and unlocking the selected purchasable feature based on the decrypted activation code.

### CROSS REFERENCE TO RELATED APPLICATION

This application claims the benefit of U.S. Provisional Application No. 62/166,830 filed May 27, 2015, which is hereby incorporated by reference in its entirety.

### TECHNICAL FIELD

The present disclosure is generally related to agricultural equipment.

### BACKGROUND

Some agricultural equipment have a requirement to unlock optional feature sets after the point of sale. Currently, unlocking features for agricultural vehicles is a manual-intensive process. Accordingly, improvements to the process are desired.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates an embodiment of an example remote vehicle feature unlock system.

FIG. 2 is a schematic diagram that illustrates an example console that may be used in an embodiment of a remote vehicle feature unlock system.

FIG. 3 is a schematic diagram that illustrates an example scanning process implemented between an example console and an example communications device in an embodiment of a remote vehicle feature unlock system.

FIG. 4 is a schematic diagram of an example communications device that may present a list of available features corresponding to a scanned code in an embodiment of a remote vehicle feature unlock system.

FIG. 5 is a schematic diagram that illustrates the receipt of an activation code in an embodiment of a remote vehicle feature unlock system based on the scanned code and selected feature of FIG. 4.

FIG. 6 is a schematic diagram that illustrates a process of entry of the activation code depicted in FIG. 5 at an example console in an embodiment of a remote vehicle feature unlock system.

FIG. 7A is a block diagram that illustrates an embodiment of an example vehicle control system with a console used in an embodiment of a remote vehicle feature unlock system.

FIG. 7B is a block diagram that illustrates an embodiment of an example console used in an embodiment of a remote vehicle feature unlock system.

FIG. 8 is a block diagram that illustrates an embodiment of an example communications device used in an embodiment of a remote vehicle feature unlock system.

FIG. 9 is a flow diagram that illustrates an embodiment of a remote vehicle feature unlock method from the perspective of an embodiment of an example control system that includes the console.

FIG. 10 is a flow diagram that illustrates an embodiment of a remote vehicle feature unlock method from the perspective of an example communications device.

### DESCRIPTION OF EXAMPLE EMBODIMENTS

### Overview

In one embodiment, a method comprising presenting, on a display screen of a console of a vehicle, a bar code; receiving an encrypted activation code at the console, the encrypted activation code based on user selection of a purchasable feature corresponding to the bar code, the purchasable feature comprising a locked feature associated with the vehicle; decrypting the encrypted activation code; and unlocking the selected purchasable feature based on the decrypted activation code.

### Detailed Description

Certain embodiments of a remote vehicle feature unlock system and method are disclosed that provide a secure way to unlock features of, or associated with, a vehicle without requiring the vehicle to have an Internet connection. In one embodiment, a remote vehicle feature unlock system enables the customer to scan features associated with a bar code (e.g., one or two-dimensional type barcodes) directly from a vehicle console to order one or more features for the vehicle via a communications device, such as a smartphone or tablet. From the communications device, which possesses Internet connectivity, the customer may order the feature(s). After the order is processed remotely, an encrypted activation code may be sent to the customer's communications device. The customer may then enter the activation code at the console, with subsequent activation of the previously locked feature(s) based on the entered activation code.

In contrast, current systems require the manual entry of information at different sites and/or by different entities (e.g., dealer, customer, service tech) to order enhanced features. With certain embodiments of remote vehicle feature unlock systems, the process may be improved.

Having summarized certain features of remote vehicle feature unlock systems of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on the agricultural equipment industry, though it should be appreciated that applications involving other industries may similarly benefit from remote vehicle feature unlock systems, and hence are contemplated to be within the scope of the disclosure. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set forth in the description.

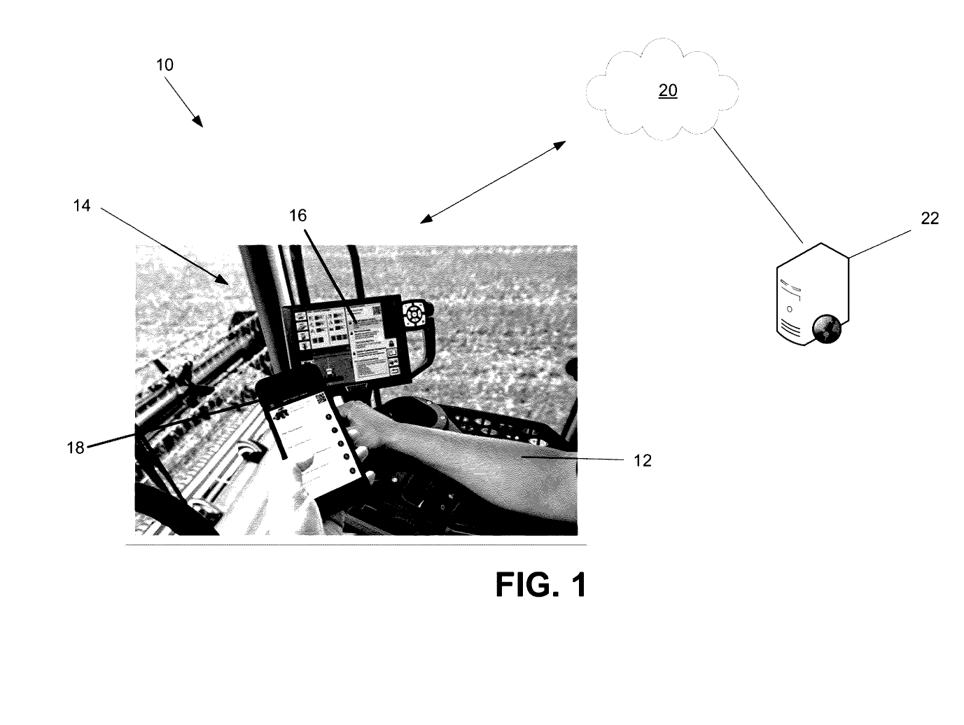

FIG. 1 is a schematic diagram that illustrates an embodiment of an example remote vehicle feature unlock system 10. It should be appreciated that the system 10 is merely illustrative of one example network environment, and that in some embodiments, fewer or greater number of components may be used. Shown is an operator 12 (his arm shown) residing in a cab of a vehicle 14, the vehicle 14 partially shown. The vehicle 14 may be an agricultural vehicle or mobile machine (the terms vehicle and mobile machine used interchangeably herein), such as a combine harvester, tractor, planter, applicators, etc. In some embodiments, stationary systems (e.g., generators) may benefit from a remote vehicle feature unlock system, and hence are contemplated to be within the scope of the disclosure. In some embodiments, the vehicle 14 may be coupled to an implement, for which features may require unlocking and subsequent use thereof. The operator 12 typically controls the vehicle 14 with the aid of a control and command console (hereinafter, merely console) 16. The console 16 may be equipped with logic (e.g., hardware and/or software) and a display screen and/or other user interface features and/or peripherals, such as a microphone, joy stick, mouse, headset, etc. The operator 12 is further shown in possession of a communications device 18. The communications device 18 may be a smartphone, tablet, among other electronic devices with Internet connectivity and that are equipped with reader software and an image sensor (e.g., camera) that enables the scanning of bar codes presented on a display screen of the console 16. The communications device 18 also comprises Internet connectivity (e.g., via well-known wireless fidelity (WiFi) and/or cellular transceiver components). Also depicted in FIG. 1 is a network 20 that enables communicative coupling between the communications device 18 and external computing devices (e.g., web server, FTP server, etc.). The network 20 may comprise a plurality of networks, such as to enable cellular, wireless fidelity, wide-area network (the Internet), and/or local area network access. At a remote location (e.g., external to the vehicle 14, such as at a manufacturer's facility or representative's facility) is a remote computing device 22. The computing device 22 is coupled to the network 20 (and through the network 20, the communications device 18), and may store (e.g., in the computing device 22 or in accessible storage) information corresponding to a plurality of vehicles, such as the vehicle 14. The information may include vehicle identification (e.g., model number and type, VIN number, etc.) and features for vehicles that are available and features that have been previously purchased, among other information. The computing device 22 may manage and/or host a web-site that presents, to Internet-connected devices, the features for purchase (e.g., purchase by the operator 12 using the communications device 18) upon receipt and decoding of the bar code transmitted by the communications device 18. The information may include purchasable (e.g., available) and purchased (e.g., historical) features specific to the vehicle 14 (and/or its associated implement). At least some of the purchasable features are locked features (i.e., where such features are inaccessible by the operator 12 until purchased after the point of sale). In other words, the vehicle 14 may have logic and/or other functionality that enables unlocking of the locked features and subsequent implementation.

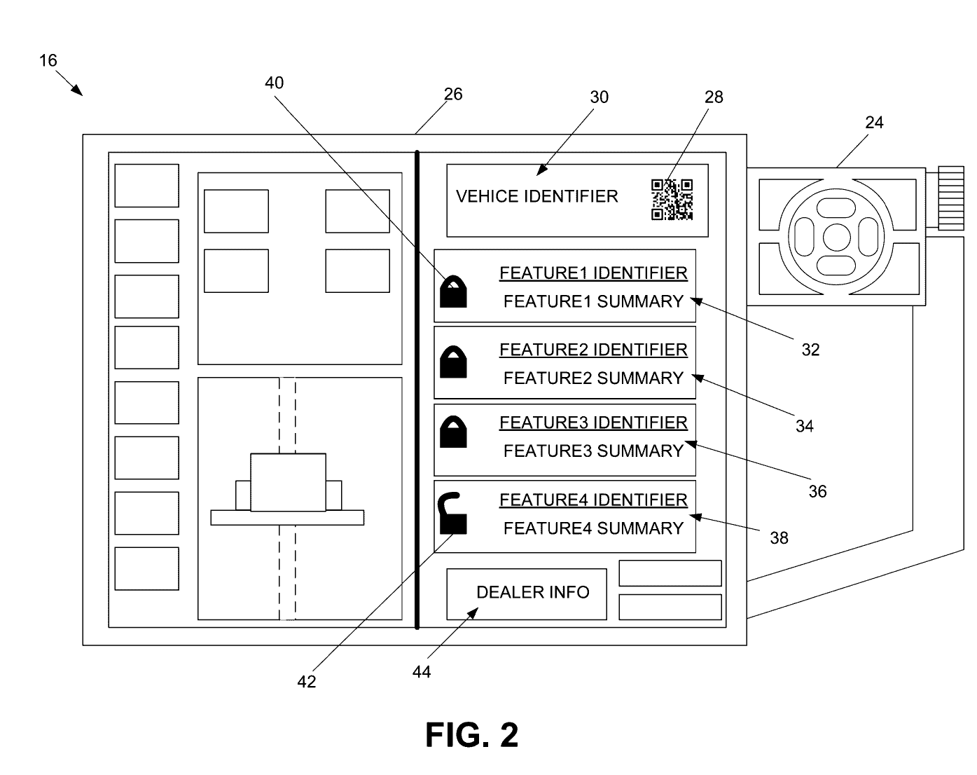

Referring now to FIG. 2, shown is an example configuration for the console 16 broadly depicted in FIG. 1. It should be appreciated that the console 16 shown in FIG. 2 is merely illustrative, and that in some embodiments, consoles with different and/or additional or fewer features may be used. The console 16 comprises a first user interface 24 and a second user interface 26. The first user interface 24 comprises a plurality of buttons, switches, and/or mechanical or electromechanical interfaces for various vehicle control functions, including optionally advancing user interface views or pages on the second user interface 26. The second user interface 26 is embodied as a touch-type display screen and presents to the operator 12 (FIG. 1), upon request, descriptions and/or identification of a plurality of available and/or purchased features for the vehicle 14 (FIG. 1). Also included in the user interface 26 are a plurality of touch-screen button icons that, upon selection, may be used to provide information pertaining to conditions in the field or in the vehicle 14, or control certain vehicle functions. In some embodiments, the second user interface 26 may present a split window presenting the feature descriptions simultaneously with task monitoring for an on-going vehicle task (e.g., including a live screen capture or representative graphic of the vehicle 14 and progress along the field), or in some embodiments, the feature descriptions may be presented alone on the screen. Although described as a touch-screen interface, in some embodiments, the touch-screen feature of the second user interface 26 may be omitted and the interface 26 is merely used to present information that is selected or manipulated using the first user interface 24. It should be appreciated that a multitude of ways of presenting and/or selecting information, including the type of information, may be presented, and hence are contemplated to be within the scope of the disclosure.

Of particular relevance to the second user interface 26 are those screen feature descriptions that present information about purchasable or purchased options. For instance, the second user interface 26 presents a bar code 28, which is presented optionally with vehicle identifying information 30. The vehicle identifying information 30 may optionally include a picture or graphic depiction of the vehicle model. The bar code 28 may be a linear or one-dimensional bar code (where information is encoded in the code in one direction (e.g., only horizontally)), or in some embodiments, a matrix style or two-dimensional bar code (e.g., where information is encoded in the code in two directions (e.g., in vertical and horizontal directions)). In the example depicted in FIG. 2, the bar code 28 comprises a two-dimensional bar code embodied as a QR code, though not limited to this type of code. Note that the depiction of the QR code in FIG. 2 is merely for illustrative purposes, with no significance as to the web-site it has actually resolved to in this example. The second user interface 26 further comprises a list of feature descriptions for respective purchasable features, the list including feature descriptions 32-36 and purchased feature description 38. Some example (yet non-limiting) features may include rate and section control, data visualization, task control enhancements, tractor implement management, additional vehicle horsepower, advanced task data management, health monitoring of software modules, service and diagnostics, virtual machine shed software modules, enhanced/extended monitoring of datasets, third party data connectors, among other features depending on the purpose of the vehicle 14 (and any implement(s) to which the vehicle 14 may be coupled). In some embodiments, the second user interface 26 may further comprise one or more feature descriptions for previously purchased features in a different view. In some embodiments, each of the feature descriptions 32-38 may comprise an identity (e.g., title) of the feature and a short descriptive summary, or in some embodiments, additional information for each feature may be accessed by selecting the screen face on the feature description of interest or in other ways, such as by selecting an information icon or other symbol among other methods known in the art. Each of the feature descriptions 32-36 is optionally presented with a lock icon, such as lock icon 40, which signifies or suggests to the operator 12 (FIG. 1) that the respective feature (e.g., features pertaining to feature descriptions 32-36) is a locked feature that may be unlocked upon a validated and completed purchase. Also shown is an unlock icon 42 associated with the feature of feature description 38, signifying that the corresponding feature has been previously purchased (and unlocked). In some embodiments, the indication of a locked and/or unlocked feature may be visualized in other and/or additional ways, such as a different in color or transparency, text description, among other methods. Other information presented to the operator may include dealer information 44, as well as screen navigation icons among other information.

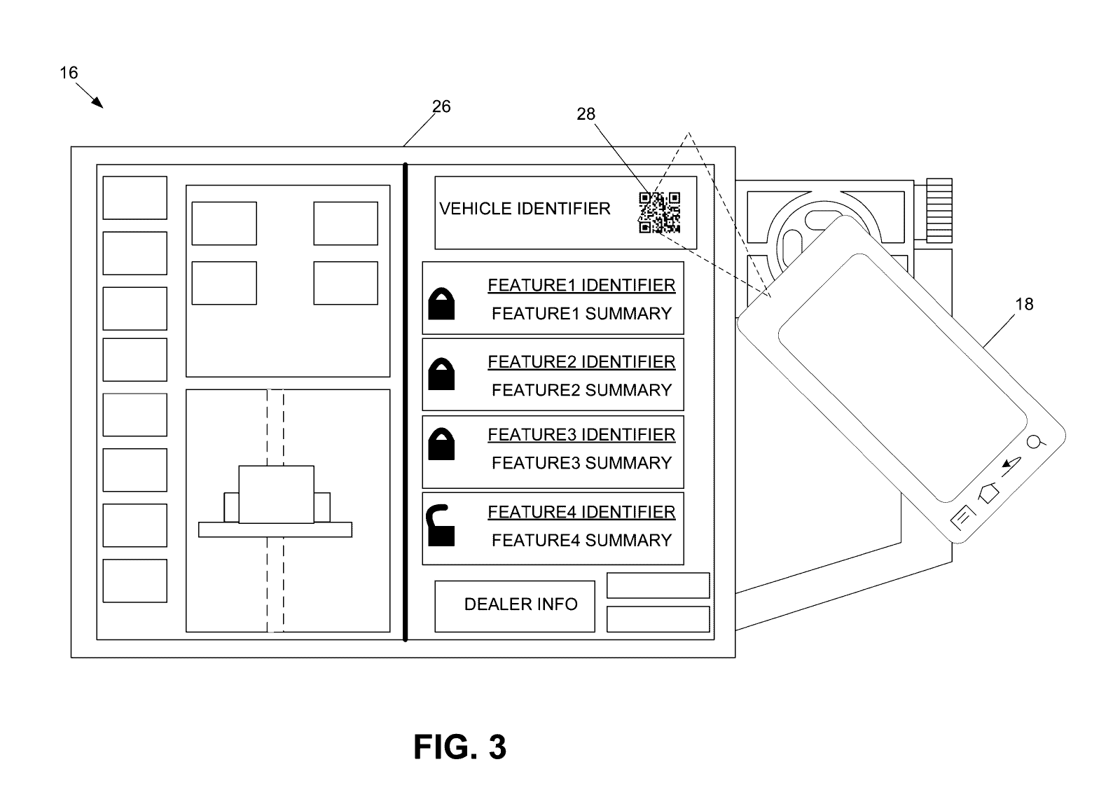

Referring to FIG. 3, shown is a schematic diagram depicting an example scanning process implemented between the console 16 and the communications device 18. Using the communications device 18, the operator 12 (FIG. 1) scans (as represented by the dashed triangle disposed between the device 18 and the console 16) the bar code 28 presented on the second user interface 26. It is noted that in practice, the image of the bar code 28 may appear on the display of the communications device 18, but is omitted in this example for brevity. The communications device 18 decodes the bar code 28 and presents a list of feature descriptions for features that are available for purchase for the vehicle 14 (FIG. 1). For instance, the communications device 18 comprises a sensor (e.g., camera) that, in association with reader software on the communications device 18 (e.g., a WR code reader), scans the bar code 28 when the communications device 18 is positioned in proximity to the bar code 28 presented on the second user interface 26. The reader software of the communications device 18 decodes the bar code 28 and presents the embedded information on the user interface of the communications device 18. In one embodiment, the information of the bar code 28 may comprise a uniform resource locator (URL) for the source of the feature information, which upon being scanned, is used by browser software in the communications device 18 to access a web page that is then presented (along with the feature descriptions) on the user interface of the communications device 18. In some embodiments, a mobile application may be used to download machine data. Variations of these and/or other mechanisms for presenting up-to-date information may be used, and hence are contemplated to be within the scope of the disclosure.

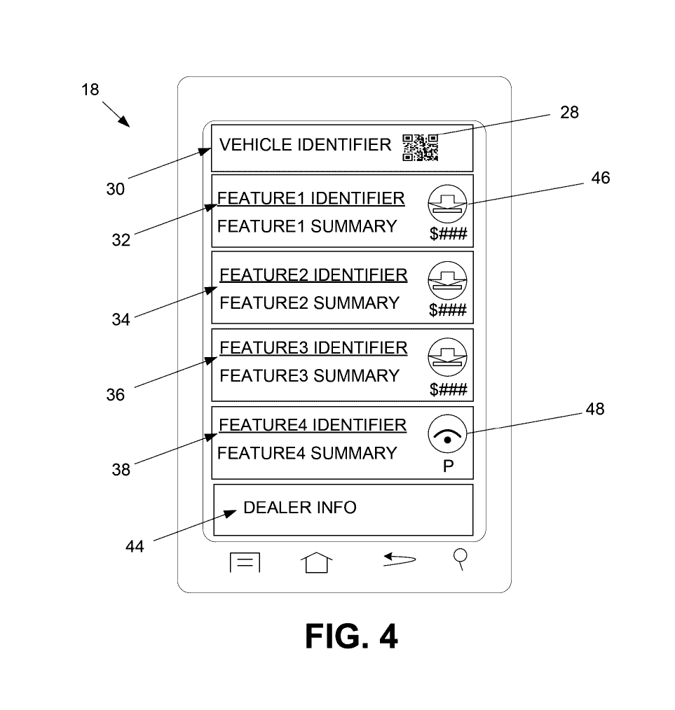

FIG. 4 is a schematic diagram of the communications device 18 after the communications device 18 is used to scan the bar code 28 from the second user interface 26 (FIG. 3) of the console 16 (FIG. 3). As shown, the communications device 18 optionally presents the bar code 28 and corresponding vehicle identifying information 30 (e.g., vehicle identifier), as well as information for the purchasable features (e.g., feature descriptions 32-36) and purchased feature (e.g., feature description 38), and dealer information 44, similar to the content and format shown in the second user interface 26 of the console 16 of FIG. 3. Each of the feature descriptions 32-38 have an associated purchase status icon, such as purchase icon 46 for the feature corresponding to feature description 32, and purchased icon 48 for the feature corresponding to feature description 38. The purchase icon 46 further includes a price of the purchasable feature (e.g., in the local currency) and has a symbol within (e.g., arrow, next text, etc.) that prompts the operator 12 (FIG. 1) to select the icon 46 to advance the ordering process. The purchased icon 48 has text (or other symbols) that suggests to the operator that the item has been purchased. In some embodiments, drop down menus among other known methods to present additional information or access to additional processes may be used. Similar to the example second user interface 26 of the console 16, additional information may optionally be shown in some embodiments, including end user license agreements, copyright notices, among other information.

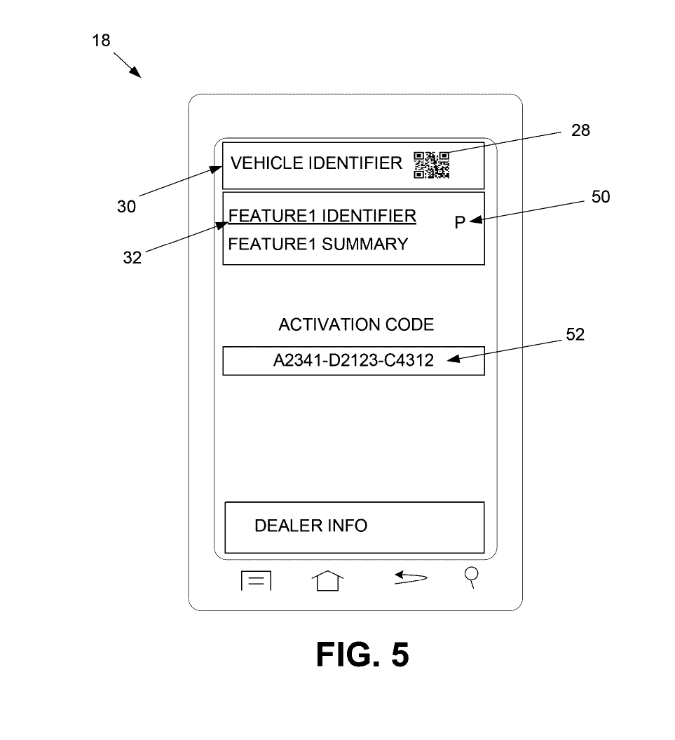

FIG. 5 shows the communications device 18 with information presented to the operator 12 (FIG. 1) that illustrates the receipt of an encrypted activation code based on, in this example, a purchase of a feature corresponding to feature description 32 of FIG. 4. In particular, the communications device 18 optionally presents the bar code 28 and identifying information 30, and further presents the feature description 32 for the recently purchased feature and an optional status identifier 50 (e.g., “P” for “Purchased”, though other symbols or indicators may be used) indicating that the feature corresponding to the purchased feature description 32 has recently been purchased. The communications device 18 also presents an activation code 52 that is to be entered at the console 16 (FIG. 2) of the vehicle 14 (FIG. 1) to enable the unlocking of the purchased feature at the vehicle 14. The value or arrangement or pattern of alphanumerics or numerics of the activation code 52 is unique to each particular vehicle 14. The activation code 52 comprises an encrypted, parsable number that, when decrypted, reveals the vehicle identification number unique for which the feature is to be unlocked and an access code that is used by software of, or associated with, the console 16 to unlock the purchased feature at the vehicle 14. In one embodiment, the access code may comprise one or more parameters, such as an application identifier (application ID) and a feature identifier (e.g., feature ID). Other and/or additional parameters may be included in some embodiments. The encryption employed may be any one of a number of well-known symmetric or asymmetric cryptographic mechanisms. Note that the value for the activation code 52 presented in FIG. 5 is merely illustrative, and not limiting as to the type of encryption mechanism contemplated to be used in some embodiments. In one embodiment, at the computing device 22 (FIG. 1), the vehicle identification embedded in the bar code 28 is used as an index to a data structure that comprises a record of the available features for that particular vehicle 14, including features that have been purchased in the past, locked, purchasable features, pricing, and dealer information. The computing device 22 updates and logs the status of the recently purchased feature, and embeds via encryption the access code and vehicle identification in the activation code 52. In some embodiments, the computing device 22 generates an invoice that may be electronically (or alternatively, physically) provided to the dealer, and the dealer in turn invoices the customer. In some embodiments, one or more intermediate communications or processes may be involved in the ordering process, such as credit checks. In some embodiments, a different chain of sale may be implemented.

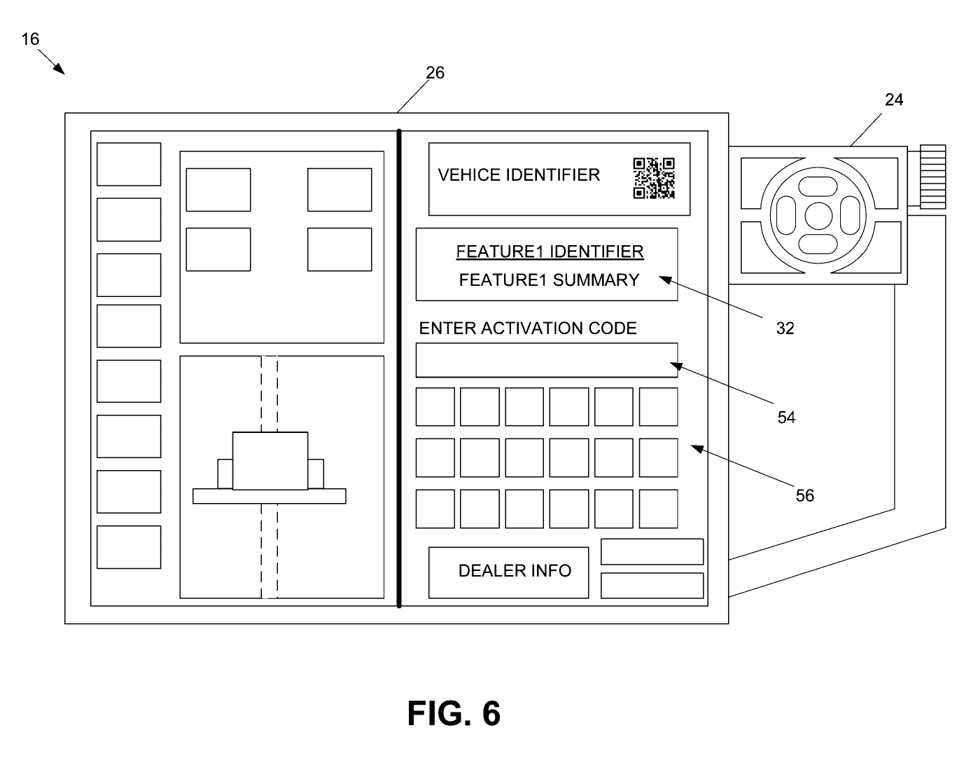

Upon receiving and presenting the activation code 52 on the communications device 18, the operator 12 (FIG. 1) in turn enters the activation code 52 at the console 16 of the vehicle 14 (FIG. 1), as shown in FIG. 6. For instance, the operator 12 (FIG. 1) may invoke a view (page) on the second user interface 26 that enables the operator 12 to view the feature description 32 for the purchased feature and enable the eventual unlocking of that feature in part through entry of the activation code 52 (FIG. 5). As show, the user interface 26 comprises an entry window 54 and touch-screen keyboard 56. The touch-screen keyboard 56 is configured based on the allowable alphanumerics or numerics (alphanumerics and numerics referred to hereinafter collectively as alphanumerics) of the encryption mechanism, and the entry window 54 presents visual feedback of the entered activation code 52. In some embodiments, the actual alphanumeric value entered may be obscured as the activation code 52 is entered. In some embodiments, as indicated previously, the operator 12 may enter the code 52 via the first user interface 24, with the second user interface 26 optionally providing visual feedback. It is noted that each key of the touch-screen keyboard 56 is shown in FIG. 6 without a corresponding alphanumeric for purposes of generality, though it should be appreciated that a letter or number or other symbol would typically be used on each key as an appropriate identifier. In some embodiments, the activation code 52 may be entered verbally through a microphone(s) integrated in, or proximal to, the console, or in some embodiments, the verbalized activation code 52 may be provided through a headset microphone that converts the audio to a corresponding signal that is communicated wirelessly (e.g., using a near field wireless protocol, such as Bluetooth, or via a wired medium in some embodiments) to the console 16. In some embodiments, the activation code 52 may be communicated to the console 16 via an upload using a communications medium (e.g., via USB ports, among other mechanisms) that couples (e.g., wirelessly or over a wired medium) the communications device 18 to the console 16.

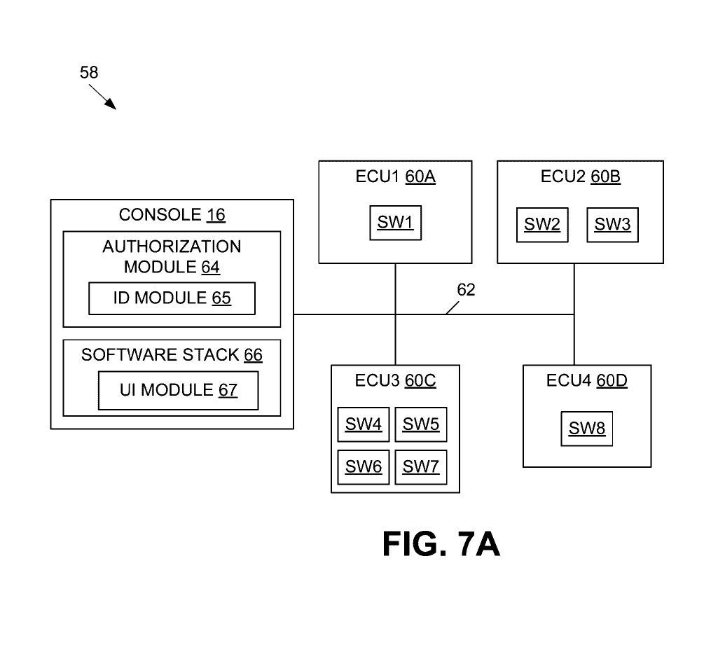

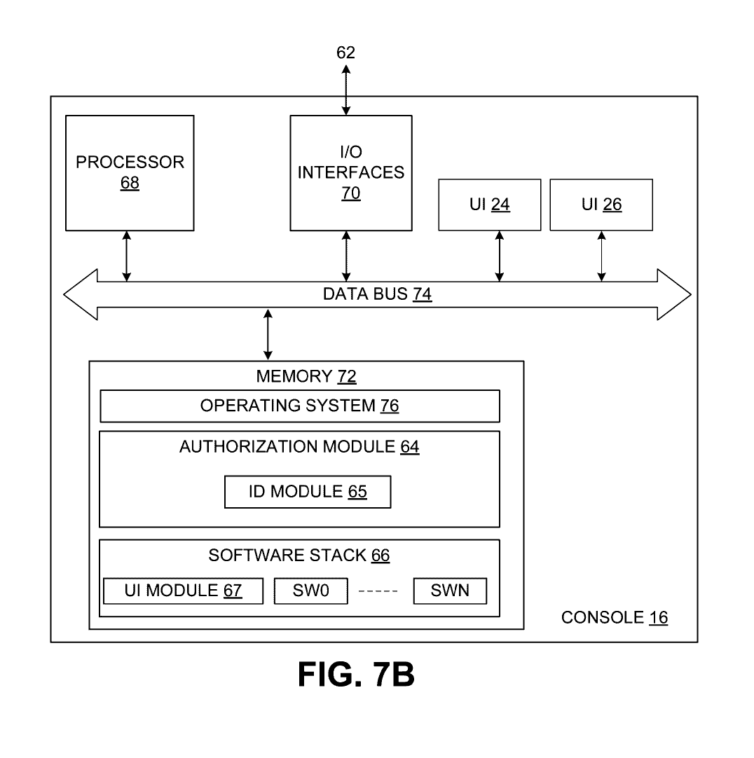

FIG. 7A is a block diagram that illustrates an embodiment of an example vehicle control system 58 that includes the console 16 used in an embodiment of a remote vehicle feature unlock system. It should be appreciated within the context of the present disclosure that some embodiments may include additional components or fewer or different components, and that the example control system 58 depicted in FIG. 7A is merely illustrative of one embodiment among others. In the depicted embodiment, the vehicle control system 58 comprises the console 16 coupled to a plurality of other nodes configured as electronic control units (ECUs) 60 (e.g., ECU1 60A, ECU2 60B, ECU3 60C, ECU4 60D, etc.) via a communications medium 62. The communications medium 62 may comprise a controller area network (CAN) bus defined according to ISO11898, as further extended under ISO 11783, and which uses in one embodiment, a physical arrangement of twisted pair wiring (e.g., typically bundled as one or more wiring harnesses). In some embodiments, other logical and/or physical configurations may be used, such as to enable RS232-based communications. In one embodiment, address claiming and/or messaging in general for each node or device connected to the communications medium 62 may be implemented according to SAE J1939, though other protocols or specifications or standards may be used in some embodiments. In some embodiments, communications among the devices 16 and 60 may be achieved via wireless fidelity (WiFi) in addition to wired protocols.

In one embodiment, the console 16 comprises an authorization module 64 and a software stack 66 for controlling one or more vehicle and/or console features. The authorization module 64 may comprise an ID module 65 for validating the vehicle identification. In some embodiments, the ID module 65 may be programmed into another device, such as one of the ECUs 60A-60D. For instance, ECU4 60D may comprise an engine ECU, and the ID module 65 may be associated with software module, SW8, or part of a separate module (or encoded with another software module within ECU4 60D). The software stack 66 may comprise a user interface module 67 that enables entry, display, and storing (e.g., to memory) of the encrypted activation code 52 (FIG. 5) entered at the console 16, among other user interface functions associated with user interfaces 24 and/or 26. The authorization module 64, as described further below, enables the unlocking of features based on decryption of the activation code 52. The software stack 66, as indicated above, may comprise a plurality of software modules, each module dedicated to particular vehicle and/or console functionality. Each of the ECUs 60 likewise comprises a software stack of one or more software modules dedicated to particular vehicle functionality. For instance, ECU 60A may comprise software module1 (SW1, such as guidance software), ECU 60B may comprise software module2 (SW2, such as transmission control software) and software module3 (SW3, such as hitch control software), and so on for ECU3 60C (e.g., SW4-SW7) and ECU4 60D (e.g., SW8). Note that reference to unlocking a purchasable feature may involve unlocking an entire software module in the console 16 or the ECUs 60, or a subset of a given software module (e.g., not the entire module, but a feature of the module) residing in the console 16 or ECUs 60. In some embodiments, multiple software modules within or among the console 16 and/or ECUs 60 may be unlocked. In some embodiments, multiple subsets within or among the software modules of the console 16 and/or ECUs 60 may be unlocked.

In one embodiment of a validation procedure, the user interface module 67 of the console 16 receives the encrypted activation code 52 (or codes in some implementations) entered in the entry window 54 (FIG. 6) of the console 16 and stores the encrypted activation code 52 in memory (e.g., non-volatile memory, such as EEPROM) of the console 16. At boot-up, the authorization module 64 accesses the memory and decrypts (using a private key) the encrypted activation code 52 to reveal a payload. The authorization module 64 parses the payload of the decrypted activation code to reveal one or more parameters. In one embodiment, the parameters comprise the vehicle ID, application ID, and feature ID. The ID module 65 of the authorization module 64 validates the vehicle ID parsed from the decrypted activation code (e.g., via comparison with a vehicle identifier stored in memory). In some embodiments, vehicle ID validation is performed elsewhere in the control system 58 (e.g., in ECU4 60D), such that the parsed vehicle ID is passed from the authorization module 64 to the ECU4 60D (e.g., after a security request over the communications medium 62 between the authorization module 64 and the ECU4 60D). In the latter embodiment, the authorization module 64 receives an acknowledgement of validation (or invalidation as the case may be, wherein access by the control system 58 is then denied). Continuing, and assuming the locked feature is on the console 16 (e.g., from a software module located in the software stack 66), the software module of the software stack 66 provides a feature access request to the authorization module 64, where the request is queued with other requests. The feature access request may be preceded by a security request in some embodiments. In one embodiment, the feature access request comprises the application ID and the feature ID. The authorization module 64 compares the decrypted and parsed activation code accessed from memory with the parameters of the feature access request, and returns a Boolean value (e.g., 0 for no access, 1 for access) indicating whether the requesting software module has access or not. Upon an indication of access (and hence a status of unlocked), the software module begins processing according to the unlocked feature. A Boolean value indicating denial indicates that the feature has not been purchased, and hence remains locked. It is noted that the example above has been given for a single purchased feature, though it should be appreciated that all of the software modules in the control system 58 perform this exchange with the authorization module 64 at boot-up, where the indication of locked or unlocked is determined before commencement of operations. In the case where the locked feature is for one or more of the software modules of the ECUs 60, a similar procedure is performed, with differences in the protocol (e.g., secure protocol and formatting of messages appropriate for exchanges over the communications medium 62).

In some embodiments, the response by the authorization module 64 to the access request may include additional information (e.g., not merely a Boolean response). For instance, in some embodiments, the purchased feature may have a time or duration component to it, where the feature is unlocked at a defined start date and expires on a defined end date. Alternatively, the purchased feature may be unlocked at a defined start date and expire after a defined quantity of hours of operation or relative hours or days after the start date. For instance, there may be multiple access keys in the activation code, each corresponding to a defined increment of time, the total quantity of keys equating to the entire duration of permitted access. The authorization module 64 may maintain a counter that decrements the key quantity per access grant, resulting in no further access after the counter has decremented to zero. The clocking mechanism may be accessed from the positioning system (e.g., Global Navigation Satellite Systems (GNSS) receiver, or elsewhere. In some embodiments, another parameter, such as initial engine hours, may be recorded into non-volatile memory (EEPROM, encrypted by the authorization module 64) with the activation code when first used, where the unlock code comprises an offset plus a predetermined duration (e.g., 20 hours).

Note that, although the description above details an example validation procedure used by an embodiment of the remote vehicle feature unlock system 10 (FIG. 1), in some embodiments, a similar procedure may be employed when entry of the activation code results in a feature reset. In a feature reset, the authorization module 64 may announce to the software modules of the control system 58 the recently purchased feature.

Further note that in some embodiments, the authorization module 64 may reside in another device, or in multiple devices that are synchronized accordingly.

Referring now to FIG. 7B, with continued reference to FIG. 7A, shown is a functional block diagram that illustrates an embodiment of the example console 16. It should be appreciated by one having ordinary skill in the art, in the context of the present disclosure, that the example console 16 is merely illustrative, and that in some embodiments, additional or fewer components may be used. In some embodiments, the functionality described below for the console 16 may be distributed among several devices or nodes. In the depicted embodiment of FIG. 7B, the console 16 is depicted as a computer system. It should be appreciated that certain well-known components of computer systems are omitted here to avoid obfuscating relevant features of the console 16. In one embodiment, the console 16 comprises one or more processors, such as processor 68, input/output (I/O) interface(s) 70, the user interfaces 24 and 26, and a memory 72, all coupled to one or more data busses, such as data bus 74. The memory 72 may include any one or a combination of volatile memory elements (e.g., random-access memory RAM, such as DRAM, and SRAM, etc.) and nonvolatile memory elements (e.g., EEPROM, ROM, hard drive, tape, CDROM, etc.). The memory 72 may store a native operating system, one or more native applications, emulation systems, or emulated applications for any of a variety of operating systems and/or emulated hardware platforms, emulated operating systems, etc. In some embodiments, the memory 72 may store in one or more data structures in memory (e.g., in non-volatile memory) keys to decrypt encrypted activation codes, keys for enabling secure communication over the communications medium 62 (FIG. 7A) with the ECUs 60, and encrypted and decrypted activation codes, as well as additional information, such as a vehicle identifier (e.g., VIN), model, type, etc. In the embodiment depicted in FIG. 7B, the memory 72 comprises an operating system 76, the authorization module 64 with the ID module 65, and the software stack 66 comprising the user interface module 67, among other software modules (SW0-SWN) for console and/or vehicle functionality. The authorization module 64 provides for the access and decryption of activation codes stored in memory 72, and the unlocking of features in response to feature access requests (including one or more parameters, such as application ID and feature ID) from the software modules of the control system 58. The ID module 65 provides for validation of the vehicle ID parameter of the activation code. In some embodiments, the ID module 65 may reside elsewhere in the console 16 (e.g., in the software stack 66) or external to the console 16 (e.g., in another ECU 60). As described previously, unlocking may involve unlocking one or more of the software modules of the software stack 66 in their entirety, or a subset of one or more of the software modules (e.g., less than all of the executable code of a given software module). In some embodiments, unlocking may involve unlocking all or a portion of software modules distributed among the console 16 and the ECUs 60, or only in one or more of the ECUs 60. The software stack 66 includes, among other software modules, the user interface module 67, which enables reception of the activation code and storage in memory 72. It should be appreciated that in some embodiments, additional or fewer software modules (e.g., combined functionality) may be employed in the memory 72 or additional memory, such as media (e.g., CAN bus) formatting and media encryption/decryption software to format and securely send and receive messages over the communications medium 62 or over the bus 74, among other functionality known to those having ordinary skill in the art. In some embodiments, a separate storage device may be coupled to the data bus 74, such as a persistent memory (e.g., optical, magnetic, and/or semiconductor memory and associated drives).

Execution of the authorization module 64, among other software, may be implemented by the processor(s) 68 under the management and/or control of the operating system 76. In some embodiments, the operating system 76 may be omitted and a more rudimentary manner of control implemented. The processor 68 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the console 16.

The I/O interfaces 70 provide one or more interfaces to the communications medium 62. In other words, the I/O interfaces 70 may comprise any number of interfaces for the input and output of signals (e.g., analog or digital data) for conveyance of information (e.g., data) over the communications medium 62.

The user interfaces 24 and 26 were described previously, and hence discussion of the same is omitted here for brevity.

When certain embodiments of the console 16 are implemented at least in part as software (including firmware), it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the console 16 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

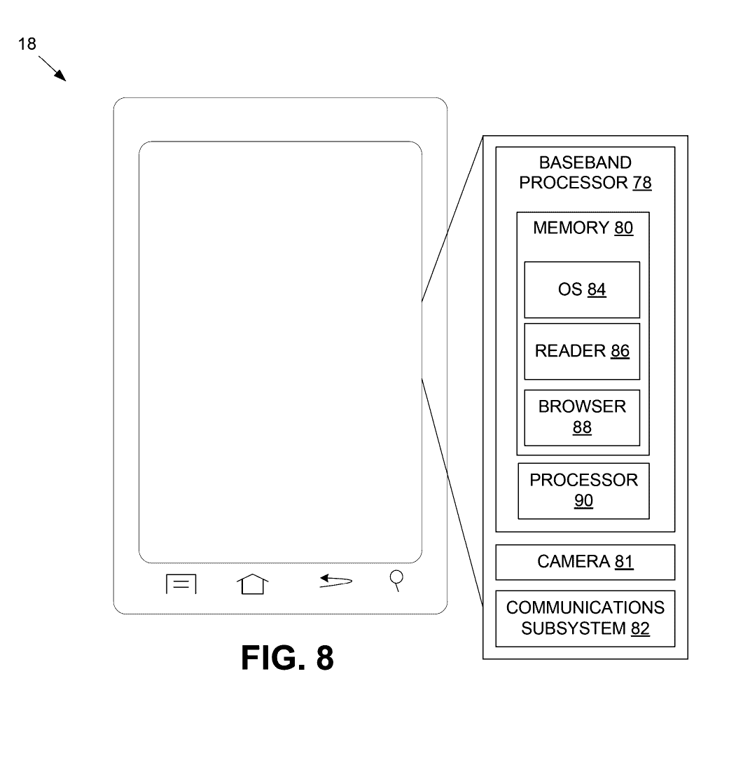

FIG. 8 is a block diagram that illustrates an embodiment of an example communications device 18. It should be appreciated by one having ordinary skill in the art that the architecture generally depicted in FIG. 8 is merely illustrative, and that some embodiments may have different features. The communications device 18 comprises a baseband processor 78. The baseband processor 78 comprises a memory 80. The memory 80 may include any one or a combination of volatile memory elements (e.g., random-access memory RAM, such as DRAM, and SRAM, etc.) and nonvolatile memory elements (e.g., EEPROM, ROM, hard drive, tape, CDROM, etc.). The memory 80 comprises an operating system (OS) 84, and application software. In one embodiment, the application software comprises bar code reader software 86 and browser software 88 to enable scanning of bar codes (in conjunction with a sensor) from the console 16 (FIG. 7B) and access to a web server (e.g., computing device 22, FIG. 1), respectively. The baseband processor 78 further comprises a processor 90 that executes the browser software 88 and the reader software 86 under the control of the operating system 84. The processor 90 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the communications device 18. The communications device 18 further comprises a camera 81 and a communications subsystem 82. The camera 81 is conventional to communications devices such as smartphone or tablets, and is used in conjunction with the reader software 86 to scan bar codes presented at the console 16. The communications subsystem 82 comprises telemetry and wireless fidelity functionality, including in one embodiment cellular and radio modem cards to access one or more networks.

When certain embodiments of the communications device 18 are implemented at least in part as software (including firmware), it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the communications device 18 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

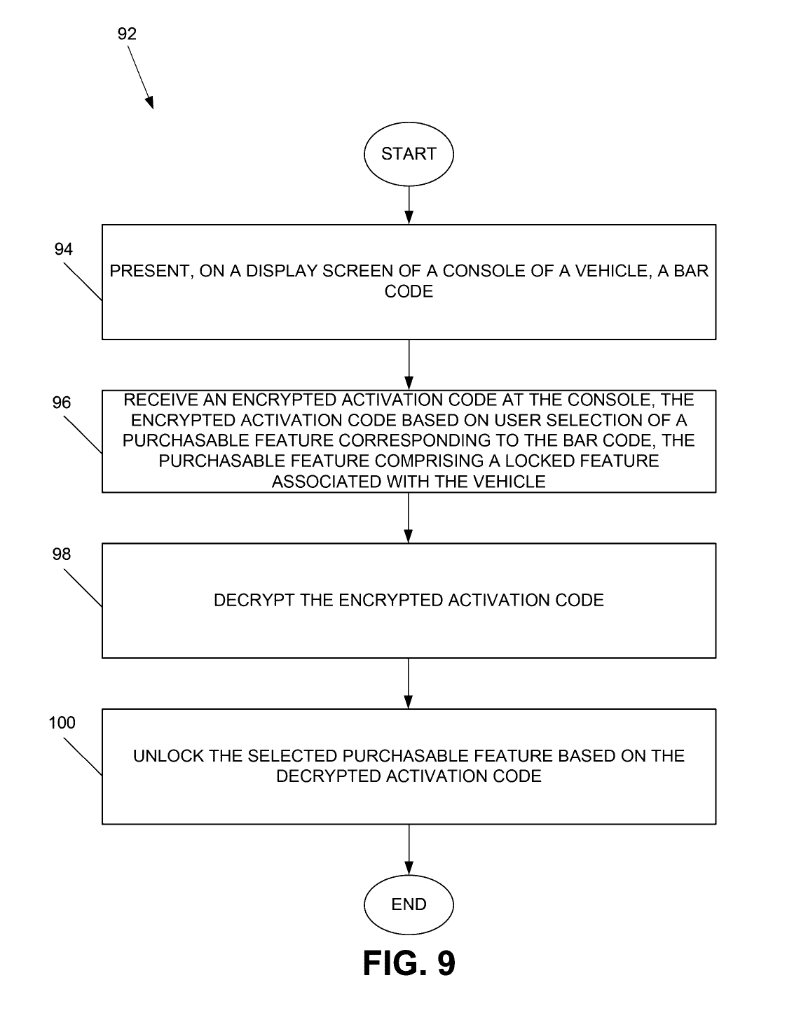

FIG. 9 is a flow diagram that illustrates an embodiment of a remote vehicle feature unlock method 92 from the perspective of the control system 58 (FIG. 7A). In one embodiment, the method 92 comprises presenting, on a display screen of a console of a vehicle. a bar code (94); receiving an encrypted activation code at the console, the encrypted activation code based on user selection of a purchasable feature corresponding to the bar code, the purchasable feature comprising a locked feature associated with the vehicle (96); decrypting the encrypted activation code (98); and unlocking the selected purchasable feature based on the decrypted activation code (100).

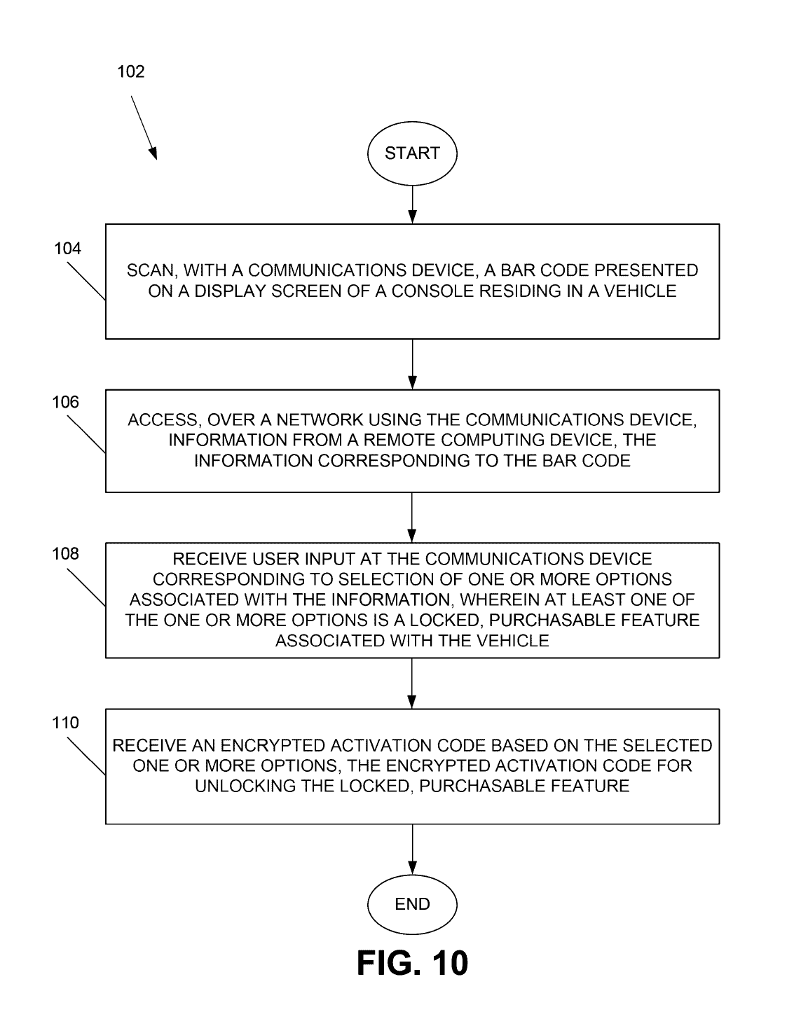

FIG. 10 is a flow diagram that illustrates an embodiment of a remote vehicle feature unlock method 102 from the perspective of the communications device 18. In one embodiment, the method 102 comprises scanning, with a communications device, a bar code presented on a display screen of a console residing in a vehicle (104); accessing, over a network using the communications device, information from a remote computing device, the information corresponding to the bar code (106); receiving user input at the communications device corresponding to selection of one or more options associated with the information, wherein at least one of the one or more options is a locked, purchasable feature associated with the vehicle (108); and receiving an encrypted activation code based on the selected one or more options, the encrypted activation code for unlocking the locked, purchasable feature (110).

Any process descriptions or blocks in flow diagrams should be understood as representing steps and/or modules, segments, or portions of code which include one or more executable instructions for implementing specific logical functions or steps in the process, and alternate implementations are included within the scope of the embodiments in which functions may be executed out of order from that shown or discussed, including substantially concurrently, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A method, comprising:
presenting, on a display screen of a console of a vehicle, a bar code;
receiving an encrypted activation code at the console, the encrypted activation code based on user selection of a purchasable feature corresponding to the bar code, the purchasable feature comprising a locked feature associated with the vehicle;
decrypting the encrypted activation code; and
unlocking the selected purchasable feature based on the decrypted activation code.

2. The method of claim 1, wherein presenting further comprises presenting on the display screen a list of available and purchased features, wherein the list of available features is presented in association with a respective icon indicating that the respective feature is a locked feature.

3. The method of claim wherein presenting is responsive to user input.

4. The method of claim 1, wherein receiving comprises receiving manual entry of the encrypted activation code on a user interface of the console.

5. The method of claim 4, wherein the user interface comprises a touch-screen interface on the display screen.

6. The method of claim 1, wherein receiving comprises receiving verbal input or a signal based on verbal input.

7. The method of claim 1, wherein receiving comprises receiving an upload from a coupled electronic device.

8. The method of claim 1, wherein unlocking comprises validating a vehicle identifier parsed from the decrypted activation code, and enabling access to the purchasable feature based on validation of one or more parameters parsed from the decrypted activation code in response to a feature access request.

9. A method comprising:
scanning, with a communications device, a bar code presented on a display screen of a console residing in a vehicle:
accessing, over a network using the communications device, information from a remote computing device the information corresponding to the bar code;
receiving user input at the communications device corresponding to selection of one or more options associated with the information, wherein at least one of the one or more options is a locked, purchasable feature associated with the vehicle; and
receiving an encrypted activation code based on the selected one or more options, the encrypted activation code for unlocking the locked, purchasable feature.

10. The method of claim 9, wherein accessing further comprises presenting on a display screen of the communications device the information, the information comprising one or more purchasable features associated with the machine corresponding to the one or more options.

11. The method of claim 9, wherein receiving user input comprises receiving tactile input, verbal input, or a signal corresponding to verbal input.

12. The method of claim 9, wherein the encrypted activation code comprises a unique vehicle identifier for the vehicle and one or more parameters used to unlock the locked feature.

13. The method of claim 9, wherein a user enters the encrypted activation code at the console.

14. The method of claim 13, wherein based on entry of the encrypted activation code, the encrypted activation code is decrypted and the locked feature is unlocked based on validation of one or more parameters of the decrypted activation code.

15. A system, comprising:
a vehicle, comprising:
a console comprising a display screen; and
a processor configured to:
present on the display screen a bar code;
receive an activation code at the console, the activation code comprising an encrypted identifier of the vehicle, the activation code based on user selection of one or more locked, purchasable features corresponding to the bar code;
decrypt the activation code; and
unlock the one or more locked, purchasable features based on the decrypted activation code.

16. The system of claim 15, wherein the processor is configured to unlock by validating the vehicle identifier parsed from the decrypted activation code, and enabling access to the one or more purchasable features based on validation of one or more parameters parsed from the decrypted activation code in response to a feature access request.

17. The system of claim 15, further comprising a communications device, the communications device comprising a processor configured to:
scan the bar code;
access, over a network, information from a remote computing device, the information corresponding to the bar code;
receive user input corresponding to selection of one or more options associated with the information, wherein at least one of the one or more options is a locked purchasable feature associated with the vehicle; and
receive the activation code based on the selected one or more options.

18. The system of claim 15, wherein the processor is configured to receive the activation code via manual entry of the activation code according to a user interface of the console.

19. The system of claim 15, wherein the processor is configured to receive the activation code via an upload according to a communications channel coupling the communications device with the console.

20. The system of claim 15, wherein the processor is configured to receive the activation code in a format of audio via a microphone coupled to the console or a signal corresponding to the audio.
